(19) United States
(12) Patent Application Publication
(10) Pub. No.: US 2008/0087814 A1
(43) Pub. Date: Apr. 17, 2008

(54) MULTI PATH TOF MASS ANALYSIS WITHIN SINGLE FLIGHT TUBE AND MIRROR

(75) Inventor: Harvey Dean Loucks, La Honda, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Loveland, CO (US)

(21) Appl. No.: 11/549,543

(22) Filed: Oct. 13, 2006

(51) Int. Cl. H01J 49/00

(52) U.S. Cl. 250/287

(57) ABSTRACT

An apparatus for analyzing ions by determining times of flight of the ions includes a flight tube. The apparatus includes a pulser for redirecting ions into the flight tube. The apparatus includes a first detector located at a first position within the flight tube. The apparatus includes a second detector located at a second position within the flight tube, wherein the pulser redirects ions in a first ion stream incident on a first flight path into a first trajectory so that ions in the first ion stream interact with the first detector, and the pulser redirects ions in a second ion stream incident on a second flight path into a second trajectory so that ions in the second ion stream interact with the second detector, and the detectors are configured to detect times of arrival of the ions.

### BACKGROUND OF THE INVENTION

The present invention relates generally to mass spectrometry systems and methods, and more particularly to systems and methods that allow for sharing components between two or more mass spectrometer systems.

Combining liquid chromatography (LC) or gas chromatography (GC) with mass spectrometry (MS) is a powerful approach to determining the concentration of target compounds in complex sample matrices. Samples may include biological fluids or environmental samples, among others.

When applying liquid or gas chromatography to a mix of compounds in a sample-containing matrix, the compounds are separated and elute from the chromatography system one after another in either a liquid or gas stream. The liquid or gas stream is then introduced into a mass spectrometer for mass spectrometric analysis. In the mass spectrometer, compounds are ionized with methods known in the art such as atmospheric pressure ionization (API), which is typical for LC/MS systems, and electron Impact Ionization (EII), which is typical for GC/MS systems.

Mass spectrometer analysis can be significantly enhanced by performing two or more stages of mass analysis in tandem (MS/MS). In the most frequently used mode of MS/MS, ions of the target compound having a particular mass-to-charge ratio (m/z) are selected by a first mass analyzer in a first stage of mass analysis from among all the ions of various m/z values formed in the ion source. The selected ions are referred to as precursor ions, and the resulting distribution of ions is called the precursor mass spectrum which is the same spectrum produced in non-tandem instruments.

Between the two stages of analysis, the ions are typically subjected to some mass changing reaction, such as collision-induced dissociation (CID) or collisionally activated dissociation (CAD), so that the succeeding mass analyzer has a different distribution of m/z values to analyze. To that end, the precursor ions are directed into a collision cell where they are energized, typically by collision with a neutral gas molecule, to induce ion dissociation and transition into fragment ions.

In the second stage of mass analysis, the fragment ions and any undissociated precursor ions pass into a second mass analyzer, such as a quadrupole analyzer, ion trap analyzer, time-of-fight analyzer or other analyzer using electromagnetic fields and ion optics. For each of the precursor ion entities, there is a corresponding distribution of reaction product ions called the product ion spectrum. The ions eventually interact with a detector system including signal processing electronics that record an ion mass spectrum at regular time intervals throughout the chromatographic separation. When the ion intensity for all combinations of the precursor and product m/z values is measured, a three dimensional array of data (precursor m/z vs. product m/z vs. intensity), commonly referred to as GC/MS/MS or LC/MS/MS data set, is produced. From each data set, mixtures of ions can be resolved without prior separation of their molecules and a great deal of structural information about individual compounds may be obtained. Tandem MS/MS instruments greatly enhance detection specificity over single-stage mass spectrometers, since ions appearing in a combination of precursor m/z and product m/z values are more specific to a particular analyte than just the precursor m/z value as given in non-tandem instruments.

While the above developments have provided significant advances in mass spectrometry, further improvements are desirable. For example, conventional MS/MS instruments typically cannot keep information about the precursor m/z after the ion is fragmented. Thus, one must fragment ions of only one m/z value at a time, passing the fragments of the selected m/z value ions on to the second stage of mass analysis. Regardless of the type of mass analyzer used for the first stage of MS in an MS/MS experiment, the first stage is used as a mass ‘filter’ in that only ions of a narrow range of m/z values are accepted from the first stage at one time. To obtain the product spectrum from ions that have other m/z values, the experiment must be repeated to produce ions from each different precursor m/z value. To achieve high throughput it is common for many different MS/MS instruments to be present in one laboratory to enable experiments to run on samples for several different target precursor m/z values at once, or more commonly to enable multiple samples to be run simultaneously.

However, acquiring several different MS/MS systems for one laboratory can be very costly. For example, the TOF analyzer is a complex instrument with many costly components such as machine base plates, electronics, vacuum manifolds, vacuum pumps, feedthrough devices, ion transport multipoles and pulser and mirror optics. It can also be wasteful to run different samples simultaneously on different machines if some of the ion optic components on the different machines provide identical functions and if the operation lifetimes are relatively long. Thus, it would be desirable to reduce the cost and/or increase the throughput of multiple MS/MS systems. In particular, it would be desirable to provide the analytic capacity of two or more MS/MS systems for less than the cost of two or more MS/MS systems.

### BRIEF SUMMARY OF THE INVENTION

The present invention relates generally to mass spectrometer systems, and more particularly to systems and mass analyzers that provide the analytic capabilities of two or more mass spectrometer systems in a single instrument.

According to an embodiment of the invention, an apparatus for analyzing ions by determining times of flight of the ions includes a flight tube. The apparatus includes a pulser for redirecting ions into the flight tube. The apparatus includes a first detector located at a first position within the flight tube. The apparatus includes a second detector located at a second position within the flight tube, wherein the pulser redirects ions in a first ion stream incident on a first flight path into a first trajectory so that ions in the first ion stream interact with the first detector, and the pulser redirects ions in a second ion stream incident on a second flight path into a second trajectory so that ions in the second ion stream interact with the second detector, and the detectors are configured to detect times of arrival of the ions. In one aspect, the pulser is configured to redirect ions in the first and second ion streams simultaneously. In another aspect, the pulser receives ions in the first ion stream from a first beam optics device, and the pulser receives ions in the second ion stream from a second beam optics device.

According to an embodiment of the invention, an apparatus for use in a mass spectrometer includes a pulser for propelling ions. The apparatus includes a first detector for detecting ions. The apparatus includes a second detector for detecting ions, wherein the pulser propels ions in a first ion stream to the first detector, the pulser propels ions in a second ion stream to the second detector, and the first and second ion streams have different initial trajectories. In one aspect, the pulser delivers pulses of ions in ascending order of their atomic mass. In another aspect, the apparatus includes a signal processor configured to generate an ion mass spectrum for ions in the first and/or second ion streams based on times of arrival of the ions detected by the detectors.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 shows a top view of a mass spectrometer system according to an embodiment of the invention.

FIG. 2 shows a top view of a mass analyzer according to an embodiment of the invention.

FIG. 3 shows a cross sectional view of a mass spectrometer system according to an embodiment of the invention.

### DETAILED DESCRIPTION OF THE INVENTION

Embodiments of the invention allow for two or more mass spectrometry systems to be contained in a single housing structure or chassis, including a single mass analyzer. For example, two or more MS/MS systems defining different MS channels may be provided in one instrument. Embodiments therefore advantageously save cost by allowing for shared components, e.g., sharing a single mass analyzer (e.g., TOF analyzer with two or more detectors), a single set of vacuum pumps, ion optics (and associated electronics), data acquisition electronics, and/or other hardware and industrial design.

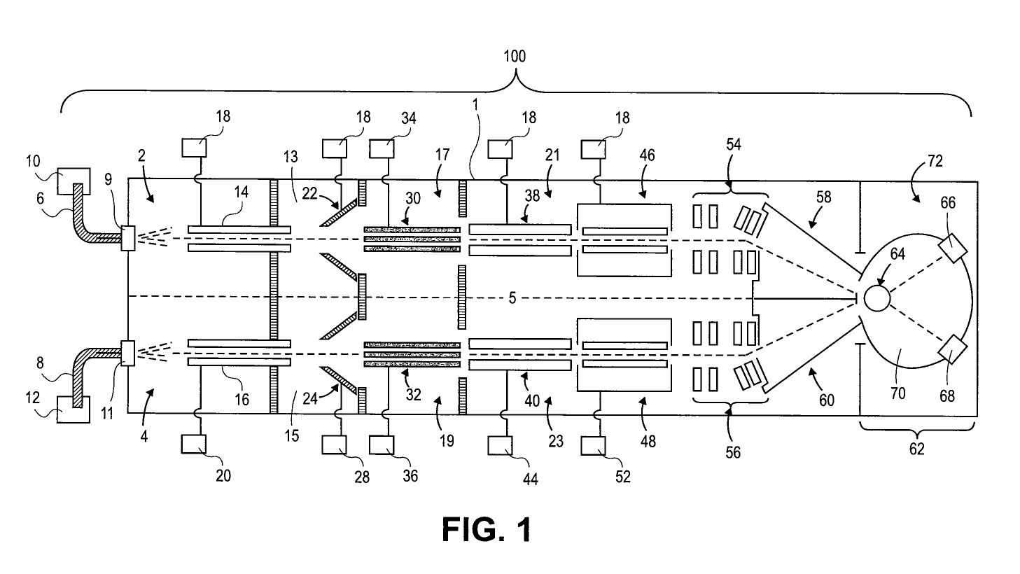

FIG. 1 shows a mass spectrometer system with shared components according to one embodiment. The system 100 shown includes a housing structure 1 that defines a chamber 5, within which two or more MS systems are housed. Each MS system is defined by an ion or MS channel extending from an ion source to an analyzer portion. A MS channel may include various components that control the flight path of ions, such as a first ion guide 30, a collision cell 46, a second ion guide 38 and a mass analyzer 62. In general, a MS channel is defined by the flight path of ions as controlled by the various MS components. As shown in FIG. 1, for example, two ion channels extend from ion sources to analyzer 62. A first channel extends from a first ion source 9 to analyzer 62, and a second channel extends from a second ion source 11 to analyzer 62. Chamber 5 may comprise a single chamber or it may comprise various sub-chambers (e.g., chambers 17 and 19, 21 and 23, etc. as will be further described later). In certain embodiments, analyzer 62 is configured with two (or more) detectors to allow for simultaneous analysis of ions from two (or more) mass spectrometer channels as will be discussed below.

In one embodiment of the invention, sample source 10 includes an analytical separation device 6 that provides a liquid containing a sample of interest to sample sprayer 9. Similarly, sample source 12 may include an analytical separation device 8 that provides a liquid containing a sample of interest to sample sprayer 1. A sample may be any liquid material, including dissolved solids, or mixture of materials dissolved in a solvent. Samples typically contain one or more components of interest, and may be derived from a variety of sources such as foodstuffs or environmental materials, such as waste water, soil or crop. Samples may also include biological samples such as tissue or fluid isolated from a subject (e.g., a plant or animal), including but not limited to plasma, serum, spinal fluid, semen, lymph fluid, external sections of skin, respiratory, intestinal and genitourinary tracts, tears, saliva, milk, blood cells, tumors, organs and also samples of in vitro cell culture constituents, or any biochemical fraction thereof. Samples may also include synthesized organic and inorganic molecules, or manufactured chemicals. Useful samples might also include calibration standards or reference mass standards.

The analyte sample(s) is supplied in a stream to ion sources 9 and 11 by analytical separation devices 6 and 8 by means well known in the art, and may be in liquid or gas form. The method of ionization may vary. However, the preferred mode of sample introduction for medium and large molecules in tandem mass spectrometry is liquid chromatography (LC/MS/MS), by which sample components are sorted according to their retention time on a column through which they pass. The various compounds that leave tubes 6 and 8 and flow into ionization regions 2 and 4 are present for some tens of seconds or less, which is the amount of time available to obtain all the information about an eluting compound. Since compounds often overlap in their elution, rapid spectral generation as provided by LC/MS/MS may enable rapidly generating each compound's elution profile and allow overlapping compounds to be separately identified.

Analytical separation devices 6 and 8 can be any liquid chromatograph (LC) device including but not limited to a high performance liquid chromatograph (HPLC), a micro- or nano-liquid chromatograph, an ultra high pressure liquid chromatography (UHPLC) device, a capillary electrophoresis (CE), or a capillary electrophoresis chromatograph (CEC) device. However, any manual or automated injection or dispensing pump system may be used. For example, in some embodiments, a liquid stream may be provided by means of a nano- or micro-pump.

A continuous stream of sample provided by analytical separation devices 6 and 8 are then ionized by devices 9 and 11, respectively. Devices 9 and 11 may be any ion source known in the art used for generating ions from an analyte sample. Examples include atmospheric pressure ionization (API) sources, such as electrospray (ESI), atmospheric pressure chemical ionization (APCI) and atmospheric pressure photoionization (APPI) sources. Other ion sources may be used.

FIG. 1 shows that the ion stream from device 9 is separate from the ion stream from device 11, so that the ions from each source may be independently produced but transferred into the same mass spectrometer system. In one embodiment of the invention, the first and second channels are housed in a single chamber. In another embodiment, a dividing wall is provided to separate the first channel from the second channel into two chambers. In another embodiment the separation is maintained by physical space and or electric fields.

Ions leaving sample sprayers 9 and 11 are respectively directed to transfer capillaries 14 and 16 that transfer ions toward the mass analyzer and allow a reduction of gas pressure from that of the ionization source chambers 2 and 4. Pressure may be reduced by one or more vacuum chambers, such as a single shared vacuum chamber, or if separate chambers are used, by separate vacuum chambers 13 and 15. Capillary 14 or 16 may be a tube, a passageway or any other such device for ion transport and pressure reduction. The mass spectrometer system in FIG. 1 further includes chambers 17 and 21 and chambers 19 and 23. The chambers are separately pumped by vacuum pumps with ions being transported through various vacuum stages of decreasing pressure until the lowest pressure is reached in a mass analyzer (e.g., vacuum chamber 72 in FIG. 1). Typically, while the spray chambers 2 and 4 are held at ambient pressure, vacuum chambers 13 and 15 are held at a pressure of about two to two and a half orders of magnitude less than ambient pressure, and the mass analyzer is held at a pressure of about six to seven orders of magnitude less than that of the chambers 13 and 15. In a preferred embodiment, each pair of similar vacuum stages (e.g. 13 and 15, 17 and 19, etc.) are pumped by one stage of a vacuum pump. The ions are then swept into vacuum chambers 17 and 19 due to the pressure difference between vacuum stages 13 and 15 and chambers 17 and 19, and due to applied electric potentials.

The ions exit transfer capillaries 14 and 16 in a continuous beam and respectively pass through skimmers 22 and 24. FIG. 1 shows skimmer 22 dividing chamber 13 from chamber 17, and skimmer 24 dividing chamber 15 from chamber 19. Skimmers 22 and 24 are known in the art to enrich analyte ions relative to neutral molecules such a solvent or gases contained in the ion beams exiting transfer capillaries 14 and 16 prior to their entries into the ion transfer optics (e.g., an ion guide, ion beam shaping or focusing lenses or the like). The ions from the first and second channels then enter first or preliminary ion guides in continuous beams.

FIG. 1 shows first or preliminary ion guides 30 and 32 in chambers 17 and 19, respectively. According to an exemplary embodiment of the invention, first ion guides 30 and 32 are octapole ion guides and are driven by power sources 34 and 36. In the embodiment shown in FIG. 1, the capillaries, skimmers, or ion guides in the first and second channels (e.g., octopoles 30 and 32) are respectively driven by separate power sources (e.g., power sources 34 and 36). In another embodiment of the invention, the capillaries, skimmers, and/or ion guides in the first and second channels are driven by common or shared power sources. Ion guides 30 and 32 may also be a radio frequency (RF) ion guide or any other type of ion guide, a stacked ring ion guide or an ion lens system. Ion guides 30 and 32 may also include a multipole structure if the power sources 34 and 36 are RF and/or DC power supplies.

After ions travel along preliminary or ion paths through first ion guides 30 and 32, they are pushed or directed into second ion guides 38 and 40 in chambers 21 and 23, respectively. As shown in FIG. 1, second ion guides 38 and 40 are driven by power sources 42 and 44 and may be any of the above types of ion guides. According to an exemplary embodiment of the invention, second ion guides 38 and 40 are quadrupoles. Other embodiments of the invention may eliminate one set of ion guides, such as first ion guides 30 and 32.

FIG. 1 shows collision cells 46 and 48 following second ion guides 38 and 40. The ions exiting ion guides 38 and 40 are “precursor” ions, and collision cells 46 and 48 allow the precursor ions to undergo reactions (e.g., fragmentation, charge stripping, EDT, m/z changing collisions, etc.) prior to entering a mass analyzer. The precursor ions are energized in collision cells 46 and 48 typically by collisions with a neutral gas molecule, such as nitrogen, helium, xenon or argon. The precursor ions are consequently dissociated into fragment ions, having a different distribution of m/z values for the mass analyzer to analyze.

FIG. 1 shows other beam optics 54 and 56 that may also be included to refocus the ion beams before they enter a mass analyzer. For example, other beam optics may also include an electric lens having an aperture, or a multiple component beam optics system. The beam optics may also include an ion lens that serves as a refocusing element to direct the ion beam into a mass analyzer. Refocusing may be accomplished by any number of ion lenses known in the art. It may be accomplished, for example, by an aperture lens, a system of aperture lenses, one or more einzel lenses, a dc quadrapole lens system, a multipole lens, a cylinder lens or system thereof, or any combination of the above lenses.

According to one embodiment, the same mass analyzer 62 is used for simultaneously analyzing ions from both first and second channels of the mass spectrometer system, corresponding to the separate flight paths of ions from ion sources 2 and 4. The fragment ions and any undissociated precursor ions from either the first flight path of ion source 2 or the second flight path of ion source 4 pass through beam converging slicers 58 and 60 into the same mass analyzer 62, which determines the m/z ratio of the ions to determine molecular weights of analytes in the samples.

Beam converging slicers 58 and 60 are beam optic devices that include apertures or slits that transfer ions with high energy into flight tube 72. In one aspect, beam converging slicers 58 and 60 are two separate apertures placed adjacent to each other. In another aspect, beam converging slicers 58 and 60 are parts of a single aperture wide enough to accept ions from both MS channels. A wider aperture may be placed closer to pulser 64 to be shared by the two channels for introducing ions from both channels to mass analyzer 62.

In another aspect, the apertures of beam optics devices 58 and 60 may be stacked on top of one another along the axis of flight tube 72, instead of being positioned adjacent to each other. However, positioning the apertures adjacent to each other is preferable in order to reduce the spatial and energy distribution of the ions along the axis of the flight tube, which improves the resolution of the mass spectrometry. The energy differences between the ions on their flight in flight tube 72 and on the path preceding pulser 64 do not affect resolution, assuming that the detectors are positioned in their proper locations to detect the ions and that the ions are not close to any fringe fields in pulser 64 or the ion mirror (not shown) of mass analyzer 62.

Moreover, while FIG. 1 shows a single bend for each ion beam at each MS channel's beam optics device 54 or 56, multiple bends of the ion beam are also possible, as is bending the ion beam after it exits beam optics device 54 or 56. In another aspect, having the two MS channels being positioned at an angle with respect to each other, rather than being parallel as shown in FIG. 1, makes it possible to avoid bending the ion beams entirely. However, such an embodiment may increase the size and cost of the vacuum system. While FIG. 1 also indicates that the ion beams cross at pulser 64, the beams may also cross at slicers 54 or 56, or the ion mirror (not shown) in the flight tube. In yet another aspect, the beams from the two channels may be parallel to each other without crossing at all.

Tandem mass spectrometers may include multiple mass analyzers operating sequentially in space or a single mass analyzer operating sequentially in time. Mass spectrometers that can be coupled to a gas or liquid chromatograph include the triple quadrupole mass spectrometer, which is widely used for tandem-in-space mass spectrometry. However, one limitation in the triple quadrupole system is that recording a fragment mass spectrum can be time consuming because the second mass analyzer must step through many masses to record a complete spectrum. To overcome this limitation, the second mass analyzer may be replaced by a time-of-flight (TOF) analyzer. One advantage of the TOF analyzer is that it can record up to 10⁴ or more complete mass spectra every second. Thus, for applications where a complete mass spectrum of fragment ions is desired, the duty cycle is greatly improved with a TOF mass analyzer and spectra can be acquired more quickly. That is, the TOF analyzer can produce product spectra at such a high rate that the full MS/MS spectrum can be obtained in one slow sweep of the quadrupole mass analyzer. Alternatively, for a given measurement time, spectra can be acquired on a smaller amount of sample.

According to one embodiment of the invention, mass analyzer 62 includes a TOF analyzer. As shown in FIG. 1, TOF analyzer 62 includes pulser 64 and detectors 66 and 68. Focused ions enter pulser 64, which pulses the ions with a voltage and sends the ions in a flight tube 70 in TOF analyzer 62. Detectors 66 and 68 are positioned to detect ions in their respective channels. In certain aspects, a TOF analyzer with an ion mirror may be used, in which case the pulsed ions enter an ion mirror (not shown) and are reflected onto the detectors 66 and 68 at the end of flight tube 70. Since all of the pulsed ions have substantially the same energy, the flight time of ions depends only on their m/z. The mass is determined by a signal processing system (not shown), that records separate data files, one data file for the first channel detected by detector 68 corresponding to the ion stream from ion source 9, and one data file for the second channel detected by detector 66 corresponding to the ion stream from ion source 11.

Ions have different velocities due to different mass-to-charge ratios (m/z) when accelerated in a vacuum by an electric field. Detectors 66 and 68 measure the time required for the ion to reach the detector after acceleration to determine this velocity at the end of the flight path in flight tube 70. For a known distance d between the acceleration region and the detector, and a flight time t between the times of acceleration and detection, the velocity v will be v=d/t ((note that where a TOF includes a mirror element, the equation will differ as is well known to one of skill in the art; note also that since the pulser does not create an infinite gradient, finite time is spent accelerating and this must also modify the equation). Since the distance is approximately the same for all ions, their arrival times differ with smaller m/z ions reaching the detector first and larger m/z ions later. Signal processing electronics then record an ion mass spectrum at time intervals, in a three-dimensional LC/MS/MS or GC/MS/MS data sets.

According to an embodiment of the invention, the analyses of ions from multiple flight paths occur simultaneously since the space charge density of the ions in pulser 64 is low enough to limit ion interaction from the different flight paths. In other embodiments of the invention, three or four different channels from three or four different ion sources may be provided in the same MS or MS/MS instrument and share the same TOF analyzer (including a corresponding number of detectors). In yet other embodiments of the invention, three or four or more channels from corresponding ion sources may be provided in the same MS/MS instrument and share two or more TOF analyzers, each one having one, two or more detectors.

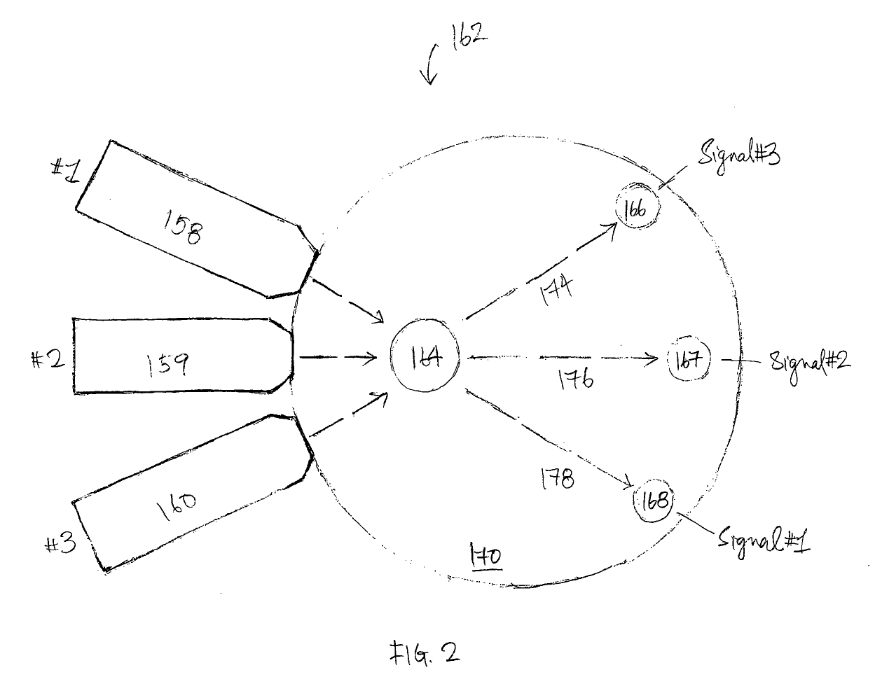

FIG. 2 shows a simplified top view of a mass analyzer coupled with three mass spectrometer channels according an embodiment of the invention. Fragment ions and undissociated precursor ions from each mass spectrometer channel enter mass analyzer 162 through beam converging slicers and/or other beam shaping optic devices of each MS channel represented by elements 158, 159 and 160. The ions may be introduced into ion pulser 164 by a variety of ion guide and pressure reduction devices such as, for example, RF containment devices comprising parallel rods or stacked discs, ion lenses and other ion optical elements. The ions from the different mass spectrometer channels enter pulser 164 and cross at different angles and eventually interact with detectors corresponding to each channel within flight tube 170. For example, ions from a first ion source and MS channel pass through beam converging slicer 158 into mass analyzer 162 along a first direction 178, and eventually interact with detector 168. Ions from a second ion source and MS channel pass through beam converging slicer 159 into the same mass analyzer 162 along a second direction 176, and eventually interact with detector 167. Ions from a third ion source and MS channel pass through beam converging slicer 160 into the same analyzer 162 along a third direction 174, and eventually interact with detector 166. Accordingly, multiple ion streams from multiple mass spectrometer channels may share all the components of mass analyzer 162 except the detectors. This greatly reduces the cost of multiple ion beam analysis. Each detector is appropriately positioned within the analyzer to detect the corresponding ion stream. For example, each detector might be positioned proximal an end of flight tube 170 as shown in FIG. 2.

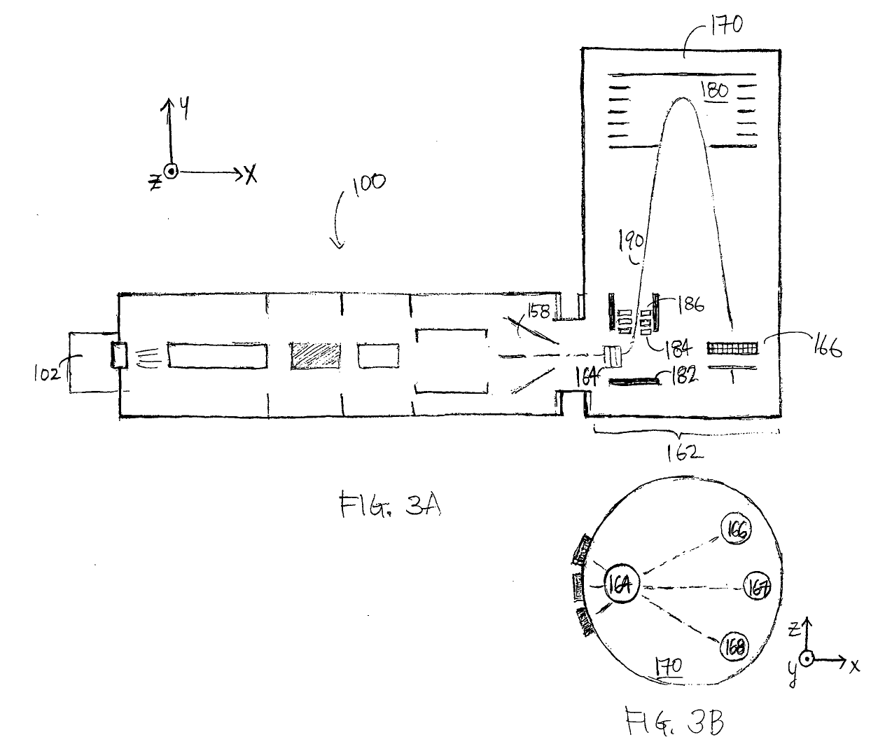

FIGS. 3A-3B shows a cross sectional view of a mass spectrometer system according to an embodiment of the invention. FIG. 3B shows a top view of mass analyzer 162 as similarly shown in FIG. 2, and FIG. 3A shows the corresponding side cross sectional view of mass analyzer 162 and flight tube 170 with respect to one channel of mass spectrometer system 100 for ion source 102. Ions from a second or third channel as shown in FIG. 2 corresponding to second or third ion sources could also be coupled with mass analyzer 162 shown in FIG. 3A (e.g., in the Z-direction).

Flight tube 170 may include a variety of materials, including various low temperature coefficient of expansion materials such as quartz, ceramic, glass or fused silica, as known in the art to be effective materials for maintaining ambient conditions of a fixed flight path over a range of environmental temperature changes, which would preserve the calibration of the instrument. Flight tube 170 may also be metallic with an insulating inner surface including layers of quartz, ceramic, glass or fused silica and other insulating materials. Flight tube 170 may have any shape or design effectively enclosing the components and multiple ion flight paths according to embodiments of the invention.

As shown in FIG. 3A, beam converging slicer 158 introduces ions from the MS channel shown into pulser device 164 of mass analyzer 162. Pulsing device 164 may include any kind of pulsing apparatus, device or combination known in the art. For example, pulsing device 164 may include ring shaped electrodes enclosing a central ion conduit region through which ions travel axially, conductive plates, grids, meshes, lenses or other devices. The plates may be spaced apart in the axial direction by insulating spacer elements. Pulsing device 164 may include a first plate for receiving a continuous ion stream and a second plate for delivering pulses of ions with a voltage. Pulsing device 164 may also include a space between electrodes for accumulating ions from the continuous ion stream before the ions are pulsed.

According to an embodiment of the invention, pulser 164 pulses ions toward a region between repeller plate 182 and acceleration grid 184. When repelling plate 182 and acceleration grid 184 are charged with different potentials, a gradient electric field is formed and ions are propelled toward ion mirror 180. The flight path 190 toward ion mirror 180 may be in a field-free region, e.g., formed using an additional grid 186 over acceleration grid 184 that is connected to ground potential. Ions are then sent on flight path 190 toward ion mirror 180, which reverses the direction of path 190 toward detector 166. Various other configurations as known in the art may be used to generate the fields to propel or redirect ions on flight path 190 toward ion mirror 180. Ions from a second or third channel corresponding to second or third ion sources are likewise propelled or redirected to ion mirror 180. The ion mirror 180 is configured such that ions from a second or third channel are redirected towards detectors 167 or 168 along the different directions shown in the top view of FIG. 3B.

While it is possible to redirect or bend the beam or beams in the pulser, in the flight tube, or in the mirror, adding additional electrical fields to do so may be less desirable because they tend to distort the desired flat equipotential lines (or equipotential surfaces) in the pulser and mirror or the field free nature of the flight tube. In other words, it is difficult to bend the beam (or beams) without creating field disturbances which shift the time arrival of the ions depending on where they are within the cross section of the beam in the flight assembly. The shifted time causes distortion of the peaks when multiple ion events are summed, resulting in decreased mass resolution. Therefore, in certain aspects, a direction for each ion beam is established, prior to the pulser, that points at its respective detector. Thus, no other special configuration in the pulser, mirror, or flight tube is needed to allow the ion beams to hit their respective detectors. To avoid the possibility of significant numbers of ions from one beam hitting the wrong detector, in certain aspects, the position and energy of each ion beam is controlled. This is done in certain aspects by selecting an appropriate beam optics device, by selecting an appropriate multipole, or by adding a discrete aperture to each beam to mask off ions of undesirable position or direction. The apertures may be simply the long side of the front slit of the slicer if separate front slits are used for each beam.

While it is desirable to avoid putting beam steering devices into the flight tube, in certain aspects, a conductive barrier that doesn't interfere with the beam is used, e.g., a wall or barrier structure positioned between the detectors to intercept those relatively few ions which might be travelling at an angle from the wrong beam path. These wayward ions are then kept from hitting the wrong detector since they either lose their charge or are scattered. While efforts are generally made to minimise wayward ions, some fringe fields can exist, occasionally an ion can hit a gas molecule despite the low pressure, ions can strike edges of apertures in the pulser or mirror, and if grids are used, ions can hit grids or be deflected by the local field disturbances of the wires or mesh. All of these effects can create ions which are not travelling “straight” from the pulser to the detector as viewed from the flight axis direction as shown FIG. 2. As long as the added barrier is conductive, electrically attached to the flight liner potential, and does not obstruct much of the beam, it can effectively shield some of the wayward ions without causing any other problems or loss of performance.

Ion mirror 180 in one aspect includes a first conductive plate or electrode held at linear potential, e.g., at the voltage of the flight tube, a second plate at a higher voltage to decelerate the ions, and a conductive repeller plate at the end. In other variations, ion mirror 180 can also include a plurality of conductive bands between the first and repeller electrodes in stepped voltages to provide a graduated field to decelerate the ions on the flight toward the repeller, and to accelerate the ions on the reversal flight toward detector 166. Other ion mirror configurations using various conductive plates, grids and spacings may be used to perform the function of reversing flight path 190, as known in the art.

Ion mirrors, or reflectrons, used to reverse the flight of ions as they travel toward a detector in a mass analyzer are advantageous for high resolution mass spectrometry. For example, ion mirrors can improve TOF mass spectrometry since the resolution is typically limited by factors of uncertainty such as time, spatial and energy distribution of ions at the pulser region. The initial spatial and energy distribution of ions at the pulser can affect the time the ions arrive at the detector, since ions with higher initial kinetic energies arrive at the detector faster than ions with lower energies. However, with the use of an ion mirror, ions with faster initial energies penetrate the repelling fields at the ion mirror more deeply before being reversed in direction toward the detector. High temporal resolution is thus enabled despite the initial spatial, energy or time distributions of ions in the pulsing region.

Embodiments of the invention provide the advantages of two or more mass spectrometry systems in a single chassis, using a single mass analyzer. Providing two or more MS/MS systems defining different channels in one instrument saves cost and improves efficiency by requiring only a single set of vacuum pumps, ion optics, data acquisition electronics, other hardware and industrial design. Two or more MS/MS systems could be obtained for a reduced cost, e.g., approaching the cost of only one system, or three or four MS/MS systems for the cost of two. Additionally, providing two or more MS/MS channels in one instrument saves the time to run two (or more) different analyses at different times, since the single instrument provides for separate functions while sharing much of the electronics and hardware.

A variety of different mass analyzers using electromagnetic fields and ion optics may be part of the mass spectrometer system in other embodiments of the invention, such as a quadrupole analyzer, a reflectron time of flight analyzer, an ion trap analyzer, an ion cyclotron mass spectrometer, Fourier transform ion cyclotron resonance (FTICR), a single magnetic sector analyzer, and a double focusing two sector mass analyzer having an electric sector and a magnetic sector. Other spectrometry systems and variations as known in the art may be used, such as for example coupling electrospray ionization (ESI) to TOF mass spectrometry (TOFMS). Other variations on the TOFMS include subjecting all the precursor ions to the fragmentation mechanism without preselection and determining the product mass with subsequent acceleration. Recent proposals also include resonant excitation in RF-only quadrupoles for CID with fragment mass analysis by TOFMS.

While the present invention has been described with reference to the specific embodiments disclosed, the invention is not limited to any particular implementation disclosed herein. For example, a radio frequency ion guide may be a quadrupole, hexapole or other multipole device, as well as a structure of rings or a multipole sliced into several segments as well known in the art. It should be understood by those skilled in the art that various changed may be made and equivalents substituted without departing from the spirit and scope of the invention. In addition, many modifications may be made to adapt a particular situation, material, composition of matter, process, process steps, to the objective, spirit and scope of the present invention. All such modifications are intended to be within the scope of the claims appended hereto.

What is claimed is:

1. An apparatus for analyzing ions by determining times of flight of the ions, comprising:
a flight tube;
a pulser for redirecting ions into the flight tube;
a first detector located at a first position within the flight tube; and
a second detector located at a second position within the flight tube;
wherein the pulser redirects ions in a first ion stream incident on a first flight path into a first trajectory so that ions in the first ion stream interact with the first detector, wherein the pulser redirects ions in a second ion stream incident on a second flight path into a second trajectory so that ions in the second ion stream interact with the second detector, and wherein the detectors are configured to detect times of arrival of the ions.

2. The apparatus of claim 1, wherein the pulser is configured to redirect ions in the first and second ion streams simultaneously.

3. The apparatus of claim 1, wherein the pulser receives ions in the first ion stream from a first beam optics device, and the pulser receives ions in the second ion stream from a second beam optics device.

4. The apparatus of claim 1, wherein ions in the first ion stream are received from a first mass spectrometer channel, and ions in the second ion stream are received from a second mass spectrometer channel.

5. The apparatus of claim 1, wherein ions in the first ion stream are generated by a first ion source, and ions in the second ion stream are generated by a second ion source.

6. The apparatus of claim 1, wherein the first trajectory from the pulser to the first detector lies on a first direction and the second trajectory from the pulser to the second detector lies on a second direction.

7. The apparatus of claim 1, wherein the pulser redirects ions across a field-free region in the flight tube.

8. The apparatus of claim 1 further comprising an ion mirror.

9. The apparatus of claim 8, wherein ions on the first flight path are propelled to the ion mirror and repelled by the ion mirror to the first detector, and wherein ions on the second flight path are propelled to the ion mirror and repelled by the ion mirror to the second detector.

10. The apparatus of claim 8, wherein the ion mirror comprises a decelerating component and a repelling component.

11. The apparatus of claim 1, further comprising a third detector at a third position within the flight tube, wherein the pulser redirects ions in a third stream incident on a third flight path into a third trajectory so that ions in the third ion stream interact with the third detector.

12. The apparatus of claim 11, wherein ions in the first ion stream are received from a first mass spectrometer channel, ions in the second ion stream are received from a second mass spectrometer channel, and ions in the third ion stream are received from a third mass spectrometer channel.

13. The apparatus of claim 11, wherein ions in the first ion stream are generated by a first ion source, ions in the second ion stream are generated by a second ion source, and ions in the third ion stream are generated by a third ion source.

14. An apparatus for use in a mass spectrometer comprising:
a pulser for propelling ions;
a first detector for detecting ions; and
a second detector for detecting ions;
wherein the pulser propels ions in a first ion stream to the first detector, the pulser propels ions in a second ion stream to the second detector, and the first and second ion streams have different initial trajectories.

15. The apparatus of claim 14, wherein the pulser delivers pulses of ions in ascending order of their atomic mass.

16. The apparatus of claim 14, further comprising a signal processor configured to generate an ion mass spectrum for ions in the first and/or second ion streams based on times of arrival of the ions detected by the detectors.

17. The apparatus of claim 14, wherein the pulser receives ions in the first ion stream from a first mass spectrometer channel, and the pulser receives ions in the second ion stream from a second mass spectrometer channel.

18. The apparatus of claim 17, wherein ions in the first ion stream are propelled on a first direction toward the first detector, and ions in the second ion stream are propelled on a second direction toward the second detector.

19. The apparatus of claim 17, wherein ions in the first ion stream are redirected along a first trajectory so that ions in the first ion stream interact with the first detector, and ions in the second ion stream are redirected along a second trajectory so that ions in the second ion stream interact with the second detector.

20. The apparatus of claim 19, further comprising an ion mirror.
